(19) United States
(12) Patent Application Publication
(10) Pub. No.: US 2010/0115502 A1
(43) Pub. Date: May 6, 2010

(54) Post Processing of Dynamically Generated Code

(76) Inventors: Azeem S. Jiva, Austin, TX (US); Gary R. Frost, Driftwood, TX (US)

Correspondence Address: HAMILTON & TERRILE, LLP - AMD, P.O. BOX 203518, AUSTIN, TX, 78720, US

(21) Appl. No.: 12/266,192

(22) Filed: Nov. 6, 2008

(51) Int. Cl. G06F 9/45

(52) U.S. Cl. 717/148

(57) ABSTRACT

A system and method are disclosed for improving the performance of compiled Java code. Java source code is annotated and then compiled by a Java compiler to produce annotated Java bytecode, which in turn is compiled by a just-in-time (JIT) compiler into annotated native code. The execution of the annotated native code is monitored with a patching agent, which captures the annotated native code as it is being executed. The captured native code is then provided through an application program interface to a dynamic linkage module, which in turn provides the captured native code to a user or to an application plug-in module for modifications. The modifications are saved as a patch. The annotated native code is then re-executed and the modifications to the annotated native code are applied as a patch by the patching agent.

### BACKGROUND OF THE INVENTION

1. Field of the Invention

Embodiments of the invention relate generally to information processing systems. More specifically, embodiments of the invention provide a system and a method for improving the performance of compiled Java code.

2. Description of the Related Art

Java is an object oriented programming language and environment that has gained wide acceptance in recent years. One aspect of Java is its portability, which has contributed to its popularity with developers of software applications. Java's approach to portability is to compile Java language code into Java bytecode, which is analogous to machine code, but is instead interpreted by a Java virtual machine (JVM) written specifically for the host computing platform. As a result, software applications written in Java can be written once, compiled once, and then run on any combination of hardware and operating system that supports a JVM. However, interpreted programs typically run slower than programs that are compiled into native executables due to the processing overhead associated with interpreting bytecode. One approach to this issue is the implementation of a just-in-time (JIT) compiler that translates Java bytecode into native code the first time the code is executed and then caches the native code in memory. This results in a program that starts and executes faster than pure interpreted code, at the cost of introducing compilation overhead during its initial execution. In addition, JIT compilers are often able to reorder bytecode and recompile for improved performance.

The performance of a software application is typically monitored through the JVM Tools Interface (JVMTI), which provides a native interface for tools such as debuggers and profilers. The JVMTI allows these tools to not only inspect the state of software applications running in a JVM, but control their execution as well. A JVMTI client, commonly referred to as an agent, is run in the same process as the software application being examined and communicates directly with the virtual machine through the JVMTI. Accordingly, agents can be controlled by a separate process which implements the bulk of a tool's function without interfering with the target application's normal execution.

Another aspect of a JVM is its ability to generate code specific to the processor that is currently executing the Java bytecode. However, current approaches fail to use this ability beyond a few code generation and flag settings for the current processor. As a result, the JVM is typically not fully optimized for the target processor. Furthermore, while some JVMTI implementations allow reordering of Java bytecode by optimization tools, the bytecode itself is not modified for optimization. Instead, the Java source code itself has to be modified and then recompiled into bytecode. This iterative process is not only time consuming, it requires experience in modifying Java source code to improve its performance.

### SUMMARY OF THE INVENTION

A system and method are disclosed for improving the performance of compiled Java code. In various embodiments, Java source code is annotated and then compiled by a Java compiler to produce Java bytecode that retains the annotations. The annotated Java bytecode is then compiled into native code, likewise with annotations, with a just-in-time (JIT) compiler. In various embodiments, the JIT compiler conforms to an annotation RetentionPolicy to determine which annotations are to be included in the native code. In these embodiments, the annotation RetentionPolicy comprises a SOURCE, CLASS, RUNTIME, COMPILE, or TOOL annotation RetentionPolicy.

In various embodiments, the execution of the annotated native code is monitored with a patching agent. In these embodiments, the patching agent likewise applies modifications as a patch to the annotated native code generated by a Java virtual machine (JVM). Native code modifications related to the patch are described in a patch description. In various embodiments, the patch description comprises a reference to a modification to a method or a function of the native code, a modification to the native code, or an instruction for applying the modifications to the native code as a patch. In these and other embodiments, the patching agent likewise captures the native code with annotations and provides it through an application program interface (API) such as a Java Virtual Machine Tool Interface (JVMTI).

The annotated native code is then executed by the JVM 144 and the patching agent determines whether annotations in the native code match a patch description. If so, then the patching agent retrieves the code modifications corresponding to the patch description and then applies the code modifications as a patch to the annotated native code. The patching agent then provides the captured native code through the JVMTI to a dynamic linkage module, which in turn provides the captured native code to a user or to an application plug-in module for analysis or modification. Modifications are made to the captured native code and saved with a unique patch description in a patch description list.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized block diagram illustrating an information processing system as implemented in accordance with an embodiment of the invention;

FIG. 2 is a simplified block diagram of a patching agent and dynamic link module as implemented in accordance with an embodiment of the invention;

FIG. 3 is a generalized flow chart of the generation of Java source code annotations as implemented a patching agent and dynamic link module in accordance with an embodiment of the invention; and

FIGS. 4a-c are a generalized flow chart of the operation of a patching agent and dynamic link module as implemented in accordance with an embodiment of the invention.

### DETAILED DESCRIPTION

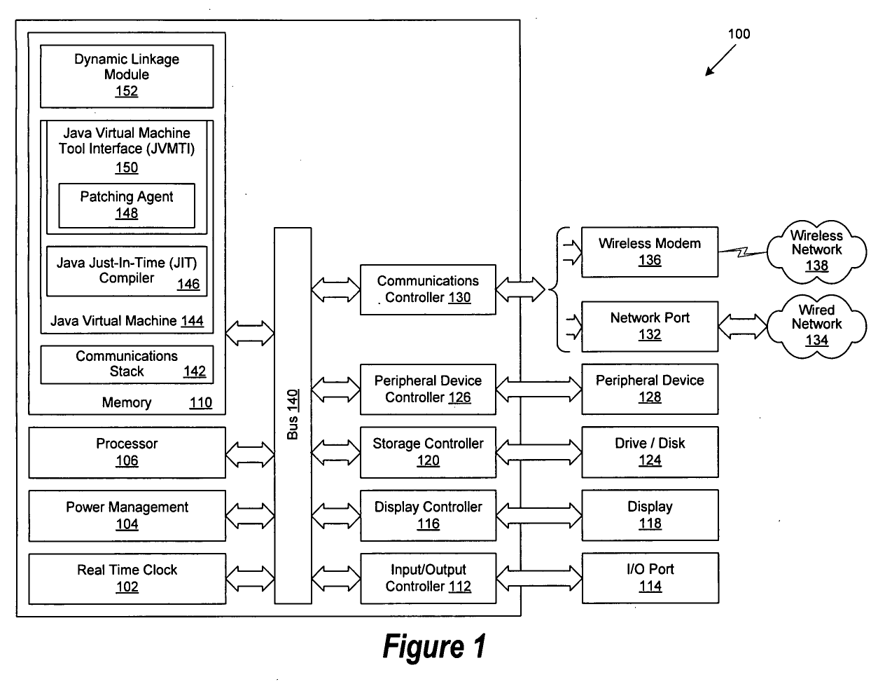

A system and method are disclosed for improving the performance of compiled Java code. FIG. 1 is a generalized block diagram illustrating an information processing system 100 as implemented in accordance with an embodiment of the invention. System 100 comprises a real-time clock 102, a power management module 104, a processor 106 and memory 110, all physically coupled via bus 140. In various embodiments, memory 110 comprises volatile random access memory (RAM), non-volatile read-only memory (ROM), non-volatile flash memory, or any combination thereof. In one embodiment, memory 110 also comprises communications stack 142, Java Virtual Machine 144 and dynamic linkage module 152. The Java virtual machine 144 further comprises a just-in-time (JIT) compiler 146 and a Java Virtual Machine Tool Interface (JVMTI) 150, which further comprises a patching agent 148.

Also physically coupled to bus 140 is an input/out (I/O) controller 112, further coupled to a plurality of I/O ports 1 14. In different embodiments, I/O port 114 may comprise a keyboard port, a mouse port, a parallel communications port, an RS-232 serial communications port, a gaming port, a universal serial bus (USB) port, an IEEE1394 (Firewire) port, or any combination thereof. Display controller 116 is likewise physically coupled to bus 140 and further coupled to display 118. In one embodiment, display 118 is separately coupled, such as a stand-alone, flat panel video monitor. In another embodiment, display 118 is directly coupled, such as a laptop computer screen, a tablet PC screen, or the screen of a personal digital assistant (PDA). Likewise physically coupled to bus 140 is storage controller 120 which is further coupled to mass storage devices such as a tape drive or hard disk 124. Peripheral device controller is also physically coupled to bus 140 and further coupled to peripheral device 128, such as a random array of independent disk (RAID) array or a storage area network (SAN).

In one embodiment, communications controller 130 is physically coupled to bus 140 and is further coupled to network port 132, which in turn couples the information processing system 100 to one or more physical networks 134, such as a local area network (LAN) based on the Ethernet standard. In other embodiments, network port 132 may comprise a digital subscriber line (DSL) modem, cable modem, or other broadband communications system operable to connect the information processing system 100 to network 134. In these embodiments, network 134 may comprise the public switched telephone network (PSTN), the public Internet, a corporate intranet, a virtual private network (VPN), or any combination of telecommunication technologies and protocols operable to establish a network connection for the exchange of information.

In another embodiment, communications controller 130 is likewise physically coupled to bus 140 and is further coupled to wireless modem 136, which in turn couples the information processing system 100 to one or more wireless networks 138. In one embodiment, wireless network 138 comprises a personal area network (PAN), based on technologies such as Bluetooth or Ultra Wideband (UWB). In another embodiment, wireless network 138 comprises a wireless local area network (WLAN), based on variations of the IEEE 802.11 specification, often referred to as WiFi. In yet another embodiment, wireless network 138 comprises a wireless wide area network (WWAN) based on an industry standard including two and a half generation (2.5G) wireless technologies such as global system for mobile communications (GPRS) and enhanced data rates for GSM evolution (EDGE). In other embodiments, wireless network 138 comprises WWANs based on existing third generation (3G) wireless technologies including universal mobile telecommunications system (UMTS) and wideband code division multiple access (W-CDMA). Other embodiments also comprise the implementation of other 3G technologies, including evolution-data optimized (EVDO), IEEE 802.16 (WiMAX), wireless broadband (WiBro), high-speed downlink packet access (HSDPA), high-speed uplink packet access (HSUPA), and emerging fourth generation (4G) wireless technologies.

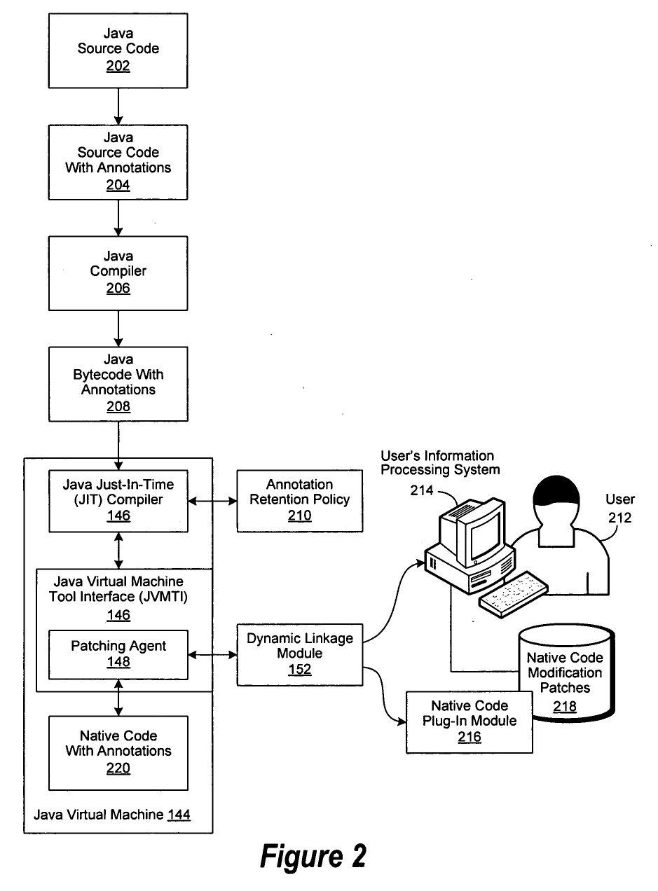

FIG. 2 is a simplified block diagram of a patching agent and dynamic link module as implemented in accordance with an embodiment of the invention. In various embodiments, Java source code 202 is annotated to produce Java source code with annotations 204. Skilled practitioners of the art will be familiar with the annotation of Java source code, which is a special form of syntactic metadata that can be added to Java source code. Java classes, methods, variables, parameters and packages may be annotated. When compiled, the Java compiler conditionally stores annotation metadata in class files if the annotation has a RetentionPolicy of CLASS or RUNTIME. In one embodiment, the RetentionPolicy further compries SOURCE, COMPILE, and TOOL. At runtime, the Java Virtual Machine (JVM) can look for the annotation metadata to determine how to interact with various program elements or to change their behavior.

The Java source code with annotations 204 is then compiled by a Java compiler 206 to produce Java bytecode 208, which retain the annotations to the source code 204. In this embodiment, Java compilation optimization operations are then begun by compiling the Java bytecode with annotations 208 into native code with annotations 220 with a just-in-time (JIT) compiler 146. In various embodiments, the JIT compiler 146 conforms to an annotation RetentionPolicy to determine which annotations are to be included in the native code with annotations 220. In these embodiments, the annotation RetentionPolicy comprises a SOURCE, CLASS, RUNTIME, COMPILE, or TOOL annotation RetentionPolicy.

In various embodiments, the execution of the native code with annotations 220 is monitored with a patching agent 148. In these embodiments, the patching agent 148 likewise applies modifications as a patch to the native code with annotations 220 generated by a Java virtual machine (JVM) 144. Native code modifications related to the patch are described in a patch description. In various embodiments, the patch description comprises a reference to a modification to a method or a function of the native code, a modification to the native code, or an instruction for applying the modifications to the native code as a patch. In these and other embodiments, the patching agent 148 likewise captures the native code with annotations 220 and provides it through an application program interface (API) such as a Java Virtual Machine Tool Interface (JVMTI) 146.

The native code with annotations 220 is then executed by the JVM 144 and the patching agent 148 determines whether annotations in the native code 220 match a patch description. If so, then the patching agent 148 retrieves the code modifications corresponding to the patch description and then applies the code modifications as a patch to the native code with annotations 220. Once the patch is applied, the patching agent 148 provides the captured native code through the JVMTI 146 to a dynamic linkage module 152, which then provides the captured native code to a user 212 or to an application plug-in module 216 for analysis or modification. Once received, the user 212 or the application plug-in module 216 generates a control flow graph (CFG) from the captured native code. The plug-in module 212, or the user 202using their information processing system 214, analyzes the CFG of the captured native code. Modifications 218 are made to the captured native code and saved with a unique patch description in a patch description list.

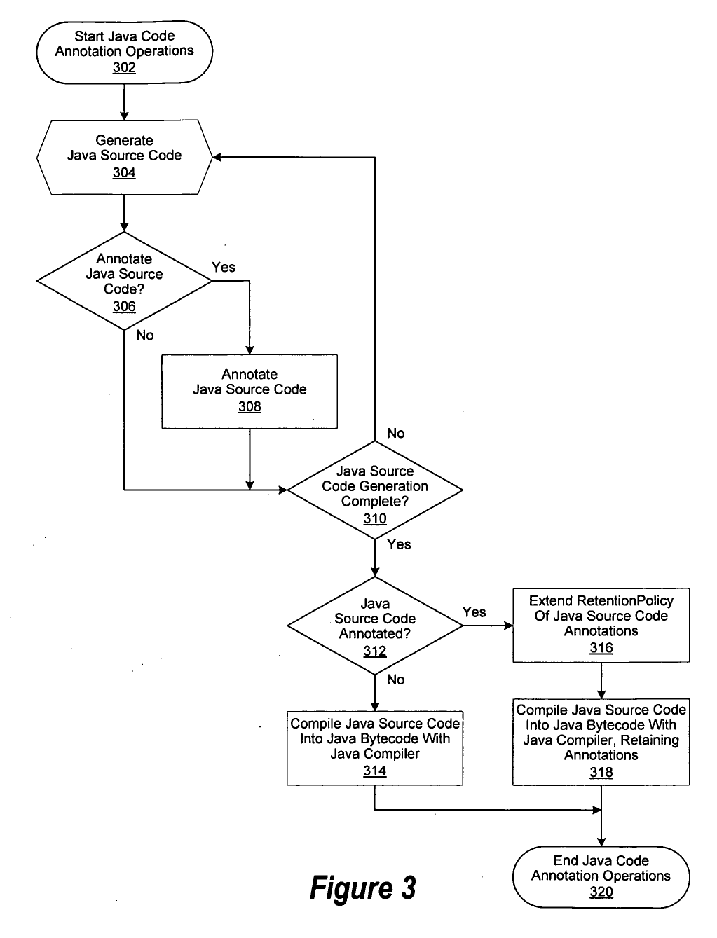

FIG. 3 is a generalized flow chart of the generation of Java code annotations as implemented a patching agent and dynamic link module in accordance with an embodiment of the invention. In this embodiment, Java code annotations are begun in block 302 followed by the generation of Java source code in step 304. A determination is made in step 306 whether to annotate the Java source code. Those of skill in the art will be familiar with the annotation of Java source code, which is a special form of syntactic metadata that can be added to Java source code. Java classes, methods, variables, parameters and packages may be annotated. When compiled, the Java compiler conditionally stores annotation metadata in class files if the annotation has a RetentionPolicy of CLASS or RUNTIME. In one embodiment, the RetentionPolicy further comprises SOURCE, COMPILE, and TOOL. At runtime, the Java Virtual Machine (JVM) can look for the annotation metadata to determine how to interact with various program elements or to change their behavior.

In various embodiments, the annotations include Java hints, which are likewise retained in the native code generated by the JIT compiler. It will be obvious to those of skill in the art that the inclusion of hints within the annotated native code allows the JIT compiler to further optimize the native code it generates. As an example:
@Rectangluar int[ ] [ ] matrix=new int [ ] [ ] {{1,0,0},{0,1,0},{1,2,1}};

In this example, the annotated array gives the compiler enough information to perform optimizations without having to do any analysis on that section of the code. In various embodiments, the present invention uses current Java mechanisms for adding annotations to the class file, such that there are no customized attribute blocks, and extending the lifespan of an annotation through to the compiler, such that:

@Retention(RetentionPolicy.SOURCE)
@Retention(RetentionPolicy.CLASS)
@Retention(RetentionPolicy.RUNTIME)
@Retention(RetentionPolicy.COMPILE)
@Retention(RetentionPolicy.TOOLS)

The COMPILE RetentionPolicy would ensure that the annotation is available to the compiler for optimization, and the TOOLS RetentionPolicy would pass information to third party tools.

A determination is then made in step 310 whether Java source code generation has been completed. If not, the process continues, proceeding with step 304. Otherwise, a determination is made in step 312 whether the Java source code is annotated. If not, then the Java source code is compiled by a Java compiler into Java bytecode in step 314. Otherwise, the RetentionPolicy of the annotations is extended in step 316 as described in greater detail herein. The Java source code is then compiled by a Java compiler into Java bytecode in step 318, retaining the annotations. Once the Java source code has been compiled into bytecode, without annotations in step 314 or with annotations in step 318, Java code annotation operations are ended in step 320.

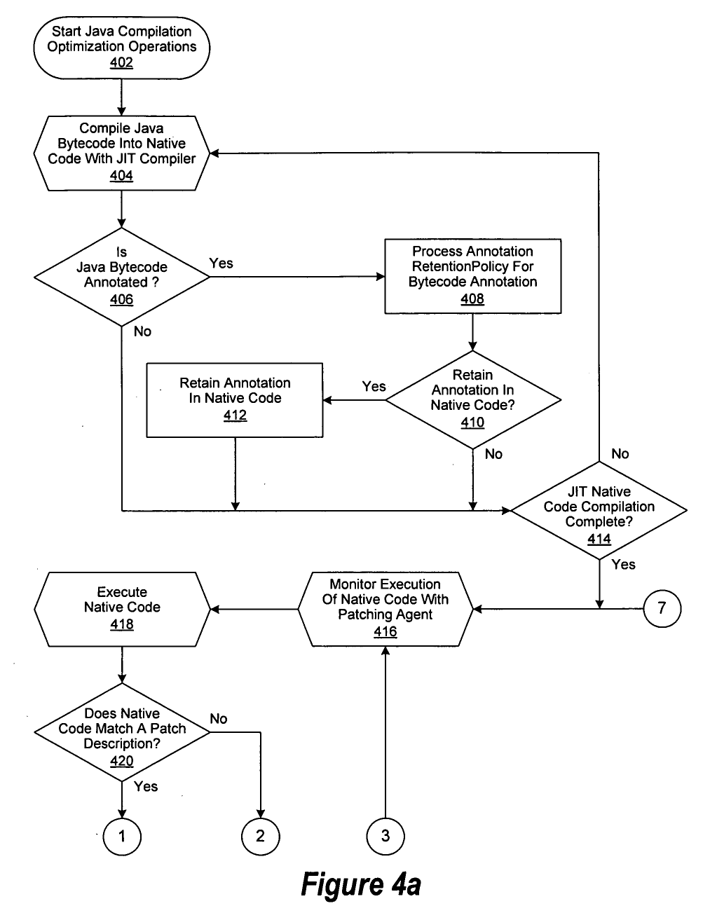

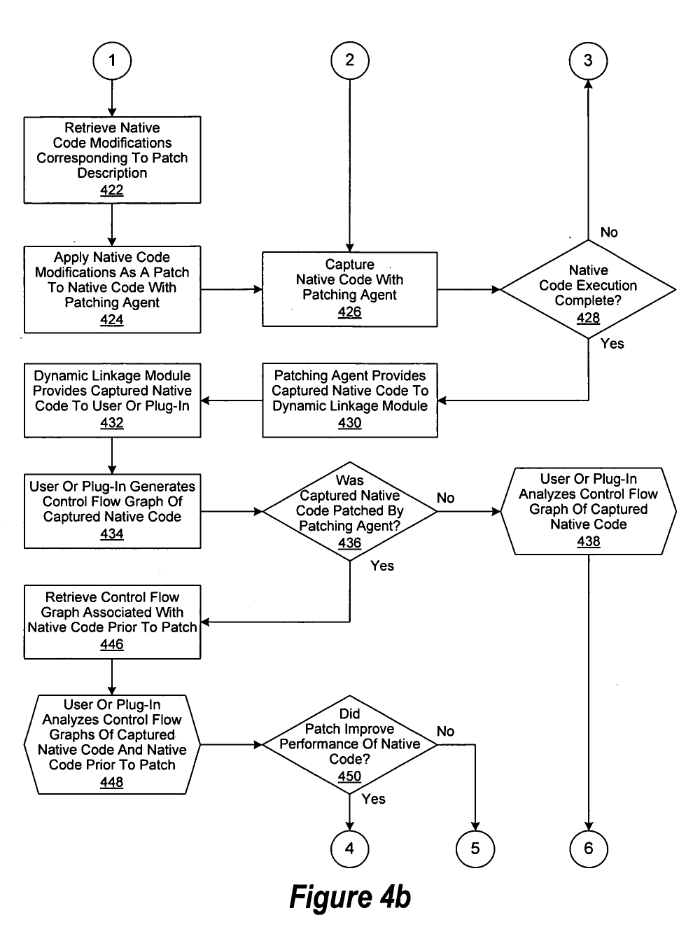

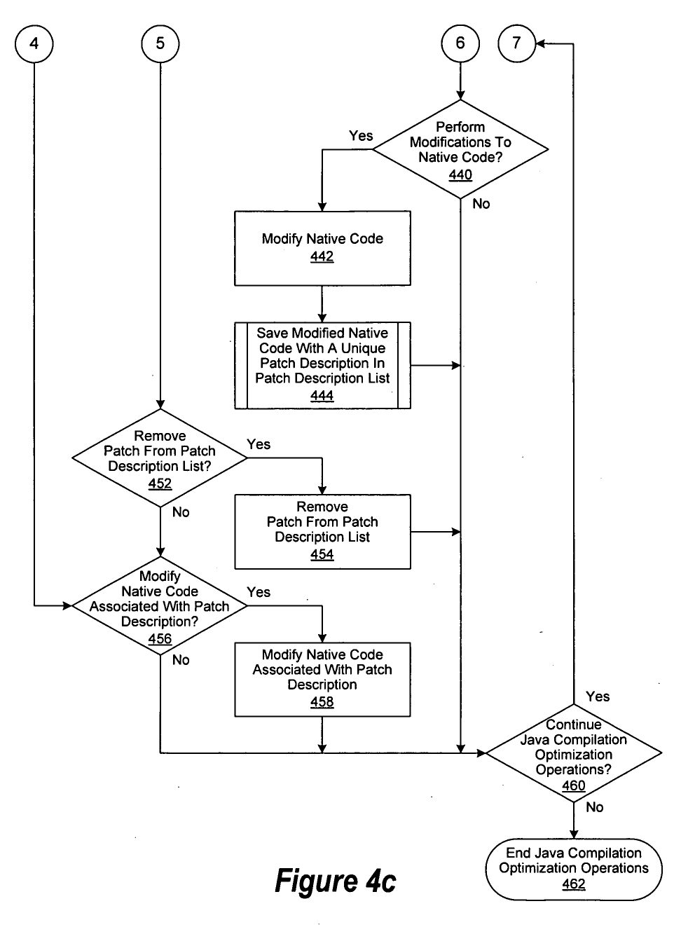

FIGS. 4a-c are a generalized flow chart of the operation of a patching agent and dynamic link module as implemented in accordance with an embodiment of the invention. In this embodiment, Java compilation optimization operations are begun in step 402, followed by the compilation of Java bytecode into native code with a just-in-time (JIT) compiler in step 404. A determination is made in step 403 whether the Java bytecode is annotated as described in greater detail herein. If so, then the JIT compiler processes the RetentionPolicy for the bytecode annotation in step 408. A determination is then made in step 410 whether the annotation is to be retained in the native code compiled from the Java bytecode by the JIT compiler. If so, the annotation is retained in the native code in step 412. In various embodiments, the JIT compiler conforms to an annotation RetentionPolicy to determine which annotations are to be included in the native code at the time of compiling the Java bytecode into native code. In these embodiments, the annotation RetentionPolicy comprises a SOURCE, CLASS, RUNTIME, COMPILE, or TOOL annotation RetentionPolicy.

However, if it is determined in step 406 that the Java bytecode is not annotated, or in step 410 not to retain the annotations in native code, or the annotation is retained in the native code in step 412, then a determination is made in step 414 whether JIT compilation is complete. If not, then the process continues, proceeding with step 404. Otherwise, the execution of the native code is monitored with a patching agent in step 416. In various embodiments, the patching agent applies modifications as a patch to native code generated by a Java virtual machine (JVM). Native code modifications related to the patch are described in a patch description. In various embodiments, the patch description comprises a reference to a modification to a method or a function of the native code, a modification to the native code, or an instruction for applying the modifications to the native code as a patch. In these and other embodiments, the patching agent likewise captures the native code and provides it through an application program interface (API). In one embodiment, the API is a Java Virtual Machine Tool Interface (JVMTI). The native code is then executed by the JVM in step 418.

A determination is then made in step 420 whether annotations in the native code match a patch description. If so, then the patching agent retrieves the code modifications corresponding to the patch description in step 422 and then applies the code modifications as a patch to the native code in step 424. Once the patch is applied in step 424, or if it is determined in step 420 that the native code does not match a patch description, then the native code is captured by the patching agent in step 426. Once the native code is captured by the patching agent, a determination is made in step 428 whether native code execution is complete. If not, then the process continues, proceeding with step 416. Otherwise, the patching agent provides the captured native code to a dynamic linkage module in step 430. In various embodiments, the dynamic linkage module receives captured native code through the API from the patching agent. In step 432, the dynamic linking module provides the captured native code to a user or to an application plug-in module for analysis or modification. Once received, a user or application plug-in module generates a control flow graph (CFG) from the captured native code.

A determination is then made in step 436 whether the captured native code was previously patched by the patching agent. If not, then the user or plug-in module analyzes the CFG of the captured native code in step 438. A determination is then made in step 440 whether to perform modifications to the captured native code. If so, then modifications are made to the captured native code in step 442 and then the modifications are saved in step 444 with a unique patch description in a patch description list. In various embodiments, the modifications comprise the reordering of instructions to improve performance and throughput, modifying the native code to use new instructions, and using more complex instructions to shrink instruction cache usage. It will be obvious to those of skill in the art that many such modifications are possible and the foregoing are not intended to limit the spirit, scope, or intent of the invention. However, if it is determined in step 440 to not perform modifications to the captured native code, or once the modifications have been made and saved in the patch description list in step 444, a determination is made in step 460 whether to continue Java compilation optimization operations. If so, then the process continues, proceeding with step 416. Otherwise, Java compilation optimization operations are ended in step 462.

However, if it is determined in step 436 that the captured was previously patched by the patching agent, then the CFG associated with the native code prior to the application of the most recent patch is retrieved in step 446. The user or plug-in module then compares the CFG of the captured native code to the CFG of the native code prior to the application of the most recent patch in step 448. A determination is then made in step 450 whether the most recent patch improved performance of the native code. If not, then a determination is made in step 452 whether to remove the modifications to the native code associated with the prior application of the patch from the patch description list. If so, then the modifications to the native code associated with the prior application of the patch are removed from the patch description list in step 454. A determination is then made in step 460 whether to continue Java compilation optimization operations. If so, then the process continues, proceeding with step 416. Otherwise, Java compilation optimization operations are ended in step 462.

Once the patch is removed from the patch description list in step 454, or if it is determined in step 450 that the most recent patch improved performance of the native code, a determination is made in step 456 whether to further modify the modifications to the native code associated with the current patch description. If so, then further modifications are made to the modifications to the native code associated with the current patch description in step 458. If not, or once the further modifications have been made in step 458, a determination is made in step 460 whether to continue Java compilation optimization operations. If so, then the process continues, proceeding with step 416. Otherwise, Java compilation optimization operations are ended in step 462.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

What is claimed is:

1. A system for improving the performance of compiled Java code, comprising:
a patching agent operable to apply modifications to native code generated by a Java virtual machine (JVM), wherein said patching agent is further operable to capture said native code and provide said captured native code through an application program interface (API); and
a dynamic linkage module operable to receive said captured native code through said API from said patching agent, wherein said dynamic linkage module is further operable to provide said captured native code for said modifications;
wherein said dynamic linkage module is further operable to receive said modifications to native code and to provide said modifications to native code to said API agent through said API;
wherein said API agent is further operable to receive said modifications to native code as input and to apply said input as a patch to said native code.

2. The system of claim 1, wherein said native code comprises annotations retained by a just-in-time (JIT) compiler at the time of compiling the Java bytecode code used to generate said native code, wherein said Java bytecode further comprises said annotations and said JIT compiler conforms to an annotation RetentionPolicy for said retention of annotations.

3. The system of claim 2, wherein said annotation RetentionPolicy comprises:
a SOURCE annotation RetentionPolicy;
a CLASS annotation RetentionPolicy;
a RUNTIME annotation RetentionPolicy;
a COMPILE annotation RetentionPolicy; and
a TOOL annotation RetentionPolicy.

4. The system of claim 2, wherein said annotations further comprise hints usable by said JIT compiler to improve performance of said native code.

5. The system of claim 1, wherein said modifications to native code comprises a patch description further comprising metadata related to at least one of:
a reference to a modification to a method of the native code;
a reference to a modification to a function of the native code;
a modification to the native code; and
an instruction for applying said modifications to native code to said native code.

6. The system of claim 5, wherein said patching agent is further operable to perform comparison operations between said native code and said patch description, wherein said comparison operations are performed at the time said native code is compiled and said modifications to native code associated with said patch description are applied as a said patch to native code when there is a match between said native code and said patch description.

7. The system of claim 1, wherein comparison operations are performed between a first control flow graph (CFG) generated from said native code and a second CFG generated from said patched native code, wherein said comparison operations provide performance information related to said native code and said patched native code.

8. The system of claim 7, wherein said native code is compiled for a predetermined processor architecture.

9. The system of claim 1, wherein said API comprises a Java Virtual Machine Tool Interface (JVMTI).

10. The system of claim 1, wherein said modifications to native code are generated by a user or a plug-in module.

11. A method for improving the performance of compiled Java code, comprising:
using a patching agent to apply modifications to native code generated by a Java virtual machine (JVM), wherein said patching agent captures said native code and provides said captured native code through an application program interface (API); and
using a dynamic linkage module to receive said captured native code through said API from said patching agent, wherein said dynamic linkage module provides said captured native code for said modifications;
wherein said dynamic linkage module receives said modifications to native code and to provides said modifications to native code to said API agent through said API;
wherein said API agent receives said modifications to native code as input and applies said input as a patch to said native code.

12. The method of claim 11, wherein said native code comprises annotations retained by a just-in-time (JIT) compiler at the time of compiling the Java bytecode code used to generate said native code, wherein said Java bytecode further comprises said annotations and said JIT compiler conforms to an annotation RetentionPolicy for said retention of annotations.

13. The method of claim 12, wherein said annotation RetentionPolicy comprises:
a SOURCE annotation RetentionPolicy;
a CLASS annotation RetentionPolicy;
a RUNTIME annotation RetentionPolicy;
a COMPILE annotation RetentionPolicy; and
a TOOL annotation RetentionPolicy.

14. The method of claim 12, wherein said annotations further comprise hints usable by said JIT compiler to improve performance of said native code.

15. The method of claim 11, wherein said modifications to native code comprises a patch description further comprising metadata related to at least one of:
a reference to a modification to a method of the native code;
a reference to a modification to a function of the native code;
a modification to the native code; and
an instruction for applying said modifications to native code to said native code.

16. The method of claim 15, wherein said patching agent is further operable to perform comparison operations between said native code and said patch description, wherein said comparison operations are performed at the time said native code is compiled and said modifications to native code associated with said patch description are applied as a said patch to native code when there is a match between said native code and said patch description.

17. The method of claim 11, wherein comparison operations are performed between a first control flow graph (CFG) generated from said native code and a second CFG generated from said patched native code, wherein said comparison operations provide performance information related to said native code and said patched native code.

18. The method of claim 11, wherein said native code is compiled for a predetermined processor architecture.

19. The method of claim 11, wherein said API comprises a Java Virtual Machine Tool Interface (JVMTI).

20. The method of claim 11, wherein said modifications to native code are generated by a user or a plug-in module.
